(19) United States
(12) Patent Application Publication
(10) Pub. No.: US 2025/0126505 A1
(43) Pub. Date: Apr. 17, 2025

(54) METHOD AND APPARATUS FOR INTEGRATION OF AI/ML TECHNOLOGIES INTO NEW RADIO SYSTEM

(71) Applicant: Soenghun KIM, Hanam-si (KR)

(72) Inventor: Soenghun KIM, Hanam-si (KR)

(21) Appl. No.: 18/905,724

(22) Filed: Oct. 3, 2024

(30) Foreign Application Priority Data
Oct. 13, 2023 (KR) 10-2023-0136847

(51) Int. Cl. H04W 24/10; H04W 76/27

(52) U.S. Cl. CPC H04W 24/10; H04W 76/27

(57) ABSTRACT

A method for integration of Artificial Intelligence (AI) and Machine Learning (ML) technologies into New Radio (NR) systems is provided. The method enables efficient transfer of AIML data over radio interface of NR system.

### CROSS-REFERENCE TO RELATED APPLICATION

This application claims priority to and the benefit of Korean Patent Application No. 10-2023-0136847, filed on Oct. 13, 2023, the disclosure of which is incorporated herein by reference in its entirety.

### BACKGROUND

### Technical Field

The present disclosure relates to integration of Artificial Intelligence (AI) and Machine Learning (ML) technologies into New Radio (NR) systems.

### Related Art

In recent years, the integration of Artificial Intelligence (AI) and Machine Learning (ML) technologies into New Radio (NR) systems has garnered significant attention. These advancements aim to enhance the performance, efficiency, and adaptability of wireless communication networks. AI/ML techniques are employed in various aspects of NR, including such as Network Optimization, Interference Management, Beamforming and Beam Management, Fault Detection and Self-Healing, User Experience Enhancement.

The integration of AI/ML in NR systems represents a significant leap forward in the evolution of wireless communication, offering unprecedented levels of efficiency, reliability, and adaptability.

For integration of AI/ML in NR systems, it is necessary to find an efficient way to transmit and receive large amounts of data.

### SUMMARY

Aspects of the present disclosure are to enhance data transfer for AI/ML integrated into NR system. The method of the terminal includes receiving from a base station a first RRC reconfiguration message, wherein the first RRC reconfiguration message comprises a first threshold, determining to transmit a first UE assistance information message to report data availability in case that amount of available data is greater than the first threshold, transmitting to the base station the first UE assistance information message, receiving from the base station a second RRC reconfiguration message wherein the second RRC reconfiguration message comprises a configuration information for data reporting, determining to transmit a second UE assistance information message to report available data in response to the configuration information for data reporting and transmitting to the base station the second UE assistance information.

### BRIEF DESCRIPTION OF THE DRAWINGS

FIG. 1A is a diagram illustrating the architecture of an 5G system and a NG-RAN.

FIG. 1B is a diagram illustrating a wireless protocol architecture in an 5G system.

FIG. 1C is a diagram illustrating a Functional framework for AI/ML for NR air interface.

FIG. 2A is a diagram illustrating overall operation of the UE and network.

FIG. 2B illustrates RRC connection establishment procedure.

FIG. 2C illustrates RRC connection reconfiguration procedure.

FIG. 2D illustrates data transfer procedure in RRC_CONNECTED state.

FIG. 3A illustrates protocol entities relevant to AI/ML operation.

FIG. 3B illustrates overall operation of the UE and network in embodiment 1.

FIG. 3C illustrates overall operation of the UE and network in embodiment 2.

FIG. 4 is a flow diagram illustrating an operation of a terminal.

FIG. 5A is a block diagram illustrating the internal structure of a UE to which the disclosure is applied.

FIG. 5B is a block diagram illustrating the configuration of a base station according to the disclosure.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
Terminal and UE and wireless device;
Information Element (IE) and set of parameters;
Parameter and field and IE;
Base station and GNB;
UAI and UEAssistanceInformation and UE assistance information message.
The integration of Artificial Intelligence (AI) and Machine Learning (ML) in New Radio (NR) systems necessitates efficient and effective data collection methods. These methods are crucial for training AI/ML models to optimize network performance, manage resources, and enhance user experiences. The following outlines various data collection techniques for NR systems:

>: Network Monitoring: Continuous monitoring of network parameters, such as signal strength, interference levels, and user mobility patterns, provides a rich dataset for AI/ML algorithms. This data is collected through network elements, including base stations and user equipment.

>: User Equipment Feedback: Data is gathered directly from user devices, including information on signal quality, data throughput, and application usage. This feedback helps in understanding user behavior and network performance from the end-user perspective.

>: Simulation and Emulation: Synthetic data is generated through network simulations and emulations, replicating various network conditions and user behaviors. This method allows for controlled data collection, enabling the training of AI/ML models under specific scenarios.

>: Environmental Sensing: Sensors deployed within the network environment collect data on physical conditions, such as temperature, humidity, and geographical features. This environmental data is used to understand its impact on network performance and optimize AI/ML models accordingly.

>: Historical Data Analysis: Historical network data is analyzed to identify patterns and trends. This retrospective analysis provides valuable insights for training AI/ML models, enabling predictive analytics and proactive network management.

The effective collection and utilization of data are fundamental to the successful implementation of AI/ML in NR systems. These methods ensure that AI/ML models are trained on comprehensive and representative datasets, leading to improved network performance and user satisfaction.

To enable efficient data collection, it is essential that UE starts and stops data transfer with sufficient controllability and self-estimation.

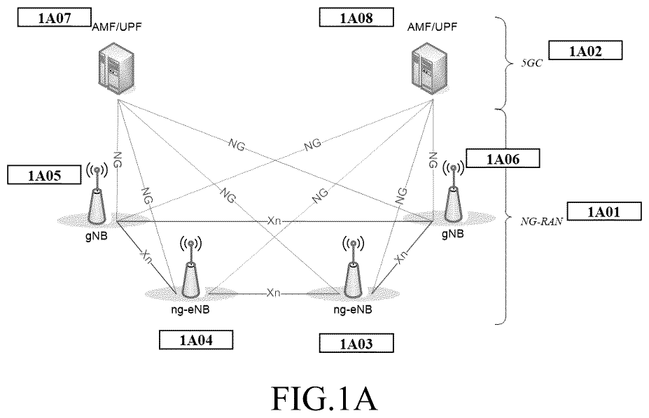

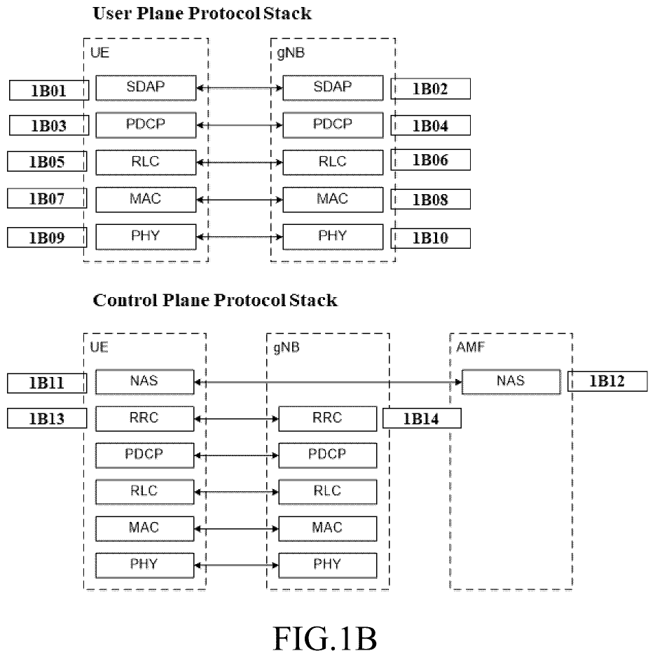

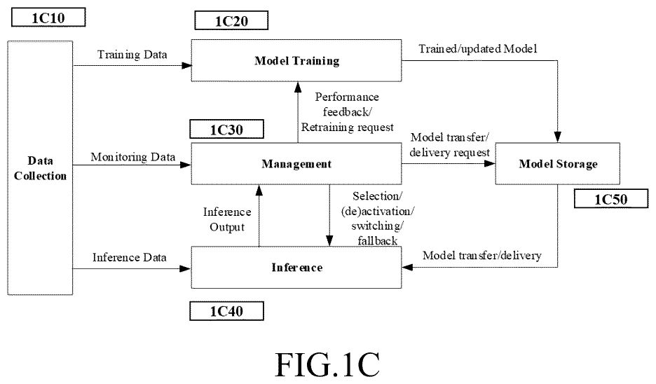

FIG. 1A is a diagram illustrating the architecture of an 5G system and a NG-RAN to which the disclosure may be applied.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

FIG. 1C illustrates functional framework of AI/ML for NR.

Data Collection 1C10 is a function that provides input data to the Model Training, Management, and Inference functions.

>: Training Data: Data needed as input for the AI/ML Model Training function.

>: Monitoring Data: Data needed as input for the Management of AI/ML Models or AI/ML functionalities.

>: Inference Data: Data needed as input for the AI/ML Inference function.

Model Training 1C20 is a function that performs AI/ML model training, validation, and testing which may generate model performance metrics which can be used as part of the model testing procedure. The Model Training function is also responsible for data preparation (e.g., data pre-processing and cleaning, formatting, and transformation) based on Training Data delivered by a Data Collection function, if required.

>: Trained/Updated Model: In case of having a Model Storage function, this is used to deliver trained, validated, and tested AI/ML models to the Model Storage function, or to deliver an updated version of a model to the Model Storage function.

Management 1C30 is a function that oversees the operation (e.g., selection/(de)activation/switching/fallback) and monitoring of AI/ML models or AI/ML functionalities. This function is also responsible for making decisions to ensure the proper inference operation based on data received from the Data Collection function and the Inference function.

>: Selection/(de)activation/switching/fallback: Information needed as input to manage the Inference function. Concerning information may include selection/(de)activation/switching of AI/ML models or AI/ML-based functionalities, fallback to non-AI/ML operation (i.e., not relying on inference process), etc. . . . .

>: Model Transfer/Delivery Request: Used to request model(s) to the Model Storage function.

>: Performance feedback/Retraining request: Information needed as input for the Model Training function, e.g., for model (re)training or updating purposes.

1C40 Inference is a function that provides outputs from the process of applying AI/ML models or AI/ML functionalities to new data (i.e., Inference Data). The Inference function is also responsible for data preparation (e.g., data pre-processing and cleaning, formatting, and transformation) based on Inference Data delivered by a Data Collection function, if required.

>: Inference Output: Data used by the Management function to monitor the performance of AI/ML models or AI/ML functionalities.

Model Storage 1C50 is a function responsible for storing trained/updated models that can be used to perform the inference process.

>: Model Transfer/Delivery: Used to deliver an AI/ML model to the Inference function.

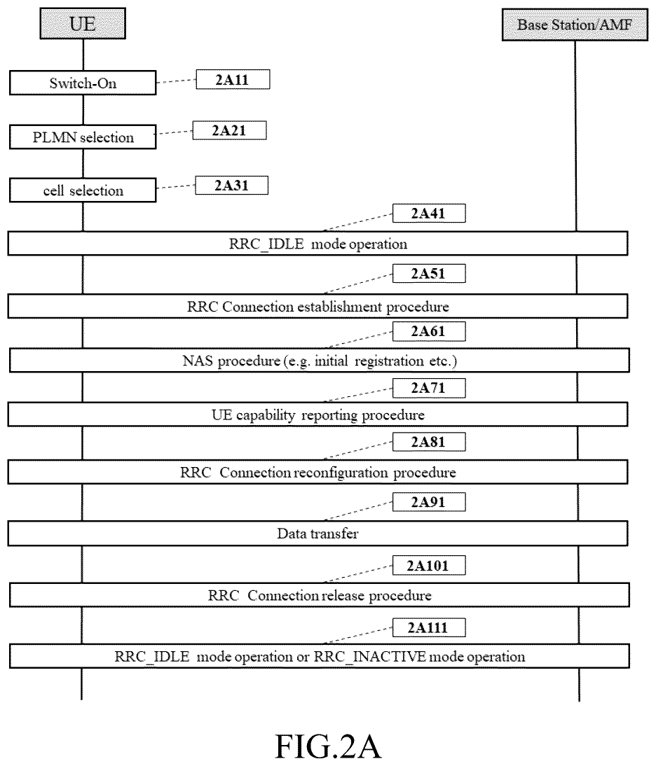

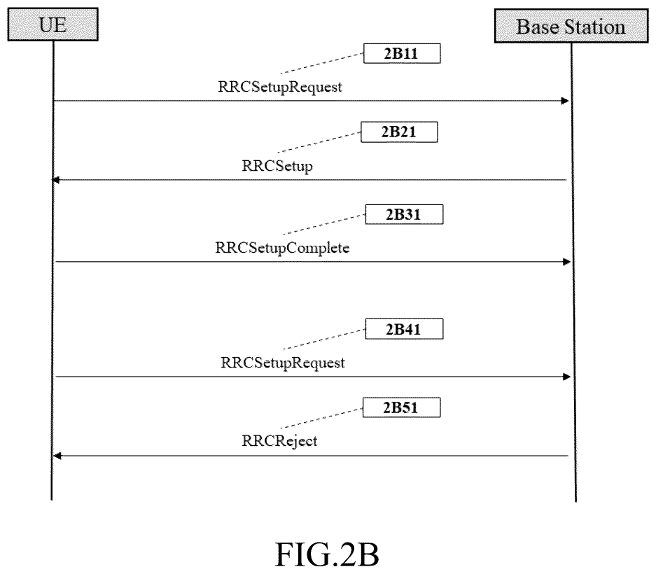

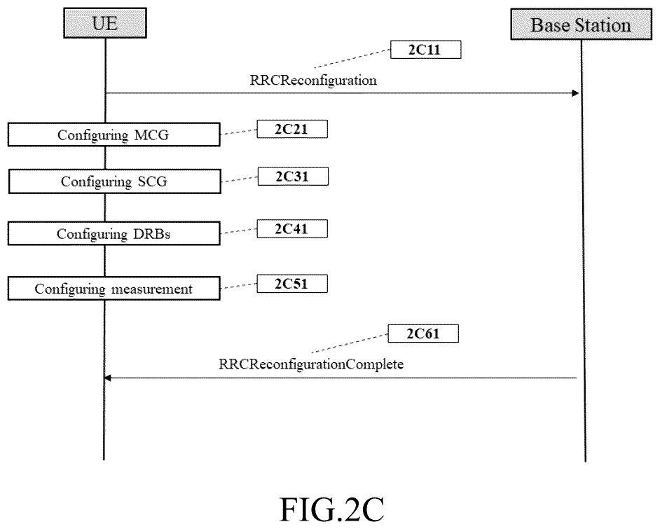

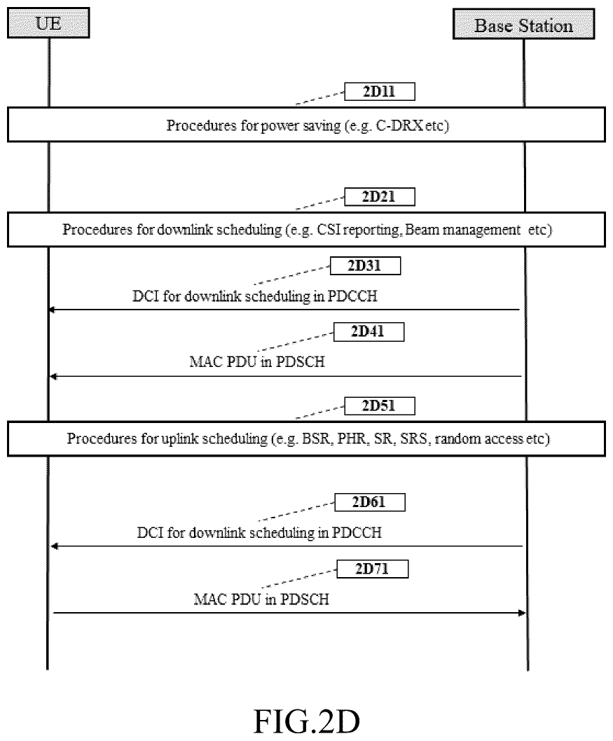

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is not longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
>1: transmission of RRCSetupRequest by the UE 2B11;
>1: reception of RRCSetup by the UE 2B21;
>1: transmission of RRCSetupComplete by the UE 2B31.

Unsuccessful RRC connection establishment procedure comprises:
>1: transmission of RRCSetupRequest by the UE 2B41;
>1: reception of RRCReject by the UE 2B51;

RRCSetupRequest comprises following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup comprises following fields and IEs:
>1: radioBearerConfig field containing a RadioBearerConfig IE;
>1: masterCellGroup field containing a CellGroupConfig IE.

RRCSetupComplete comprises following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

FIG. 2C illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2C11 and RRCReconfigurationComplete 2C61 between the base station and the UE.

RRCReconfiguration may comprises following fields and IEs:
>1: rrc-TransactionIdentifier field contains a RRC-TransactionIdentifier IE;
>1: radioBearerConfig field contains a RadioBearerConfig IE;
>>2: radioBearerConfig field comprises configuration information for SRBs and DRBs via which RRC messages and user traffic are transmitted and received;
>1: secondaryCellGroup field contains a CellGroupConfig IE;
>>2: secondaryCellGroup field comprises configuration information for secondary cell group;
>>2: A cell group consists of a SpCell and zero or more SCells;
>>2: Cell group configuration information comprises cell configuration information for SpCell/SCell and configuration information for MAC and configuration information for logical channel etc;
>1: measConfig field contains a MeasConfig IE;
>>2: measConfig field comprises configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2C21;
>1: perform the cell group configuration for SCG based on the received secondaryCellGroup 2C31;
>1: perform the radio bearer configuration based on the received radioBearerConfig 2C41;
>1: perform the measurement configuration based on the received measConfig 2C51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2D illustrates data transfer procedure in RRC_CONNECTED state.

The UE and the base station may perform procedures for power saving such as C-DRX 2D11. The configuration information for C-DRX is provided to the UE within cell group configuration in the RRCReconfiguration.

The UE and the base station may perform various procedures for downlink scheduling 2D21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2D31. The base station transmits to the UE PDSCH corresponding to the DCI and containing a MAC PDU 2D41.

The UE and the base station may perform various procedure for uplink scheduling 2D51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2D61. The base station transmits to the UE PDSCH corresponding to the DCI and containing a MAC PDU 2D71.

SRB stands for Signaling Radio Bearer, used for transmitting signaling messages between the network and the user terminal. Its main function is to handle control plane signaling.

SRB0 is used for initial connection setup and transmission of system information messages. SRB1 primarily handles RRC (Radio Resource Control) messages and NAS (Non-Access Stratum) signaling, playing a crucial role in initial connection establishment and reestablishment processes. SRB2 is similar to SRB1 but is used for encrypted message exchanges. SRB3 is an additional control channel designed for high data rate transfers, helping to enhance network performance in high-traffic situations. SRB4 is mainly utilized to improve Quality of Experience (QoE), monitoring and adjusting real-time network conditions to optimize user experience. This ensures that users receive smoother and more stable service quality.

SRB5 is used for transmitting AIML related signaling and its segments. AIML data is transmitted on either SRB1, SRB2 or SRB5 depending on type and amount of AIML data. SRB5 has lower priority than SRB0, SRB1 and SRB2.

This is to prevent low-critical AIML data from delaying critical control plane signaling.

In the disclosure, several embodiments are present.

In Embodiment 1:
>training data collection starts based on AMM control signal; and
>training data reporting is controlled by RRC:
>>UAI is used in embodiment 1-1;
>>UEInformationResponse is used in embodiment 1-2.

In Embodiment 2:
>training data collection starts based on RRC message; and
>training data reporting is controlled by RRC:
>>UAI is used in embodiment 2-1;
>>UEInformationResponse is used in embodiment 2-2.

AMM container, AIML data and AMM data are used interchangeably.

Control data being terminated in a protocol entity means that:
>the control data is generated/processed/used in the entity; and
>the control data is not blindly forwarded to the upper layer when the control data is delivered from lower layer; and
>the control data is not blindly forwarded to the lower layer when the control data is delivered from upper layer.

Control data being terminated in upper layer means that:
>lower layer blindly forwards (forwards without processing) the control data to the upper layer when delivered from the lower layer;
>lower layer blindly forwards the control data to the further lower layer when delivered from the upper layer.

SRB5 conveys:
>RRC terminated RRC message in the uplink (e.g. UAI or UEInformationResponse); and
>AMM terminated RRC message in the downlink (e.g. AMMDirectTransfer).

AMMDirectTransfer:
>comprises one or more AMM containers;
>comprises control data that is terminated in the AMM entity (upper layers); and
>does not comprise control data that is terminated in the RRC.

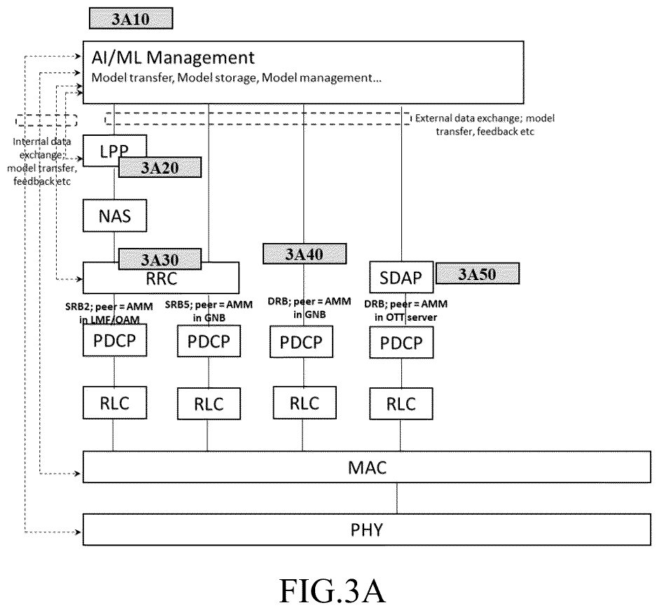

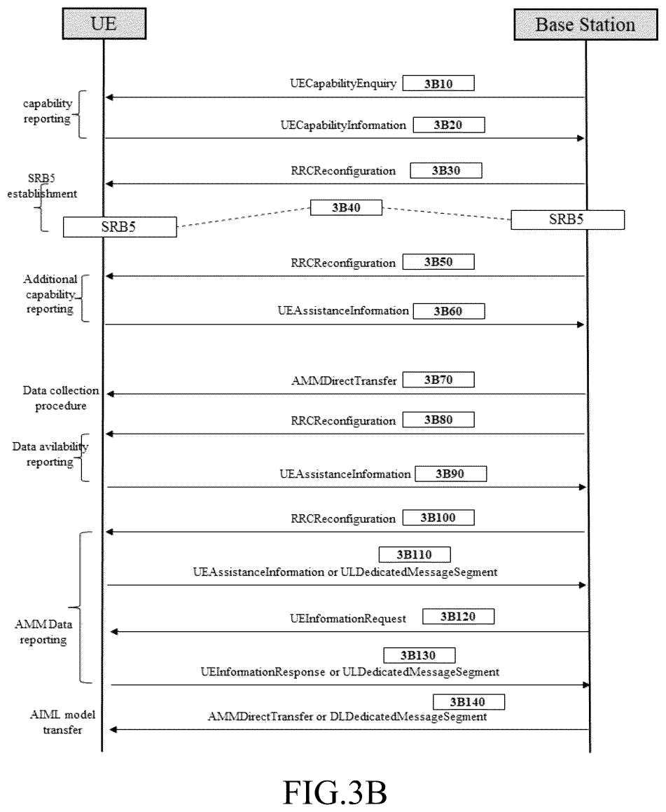

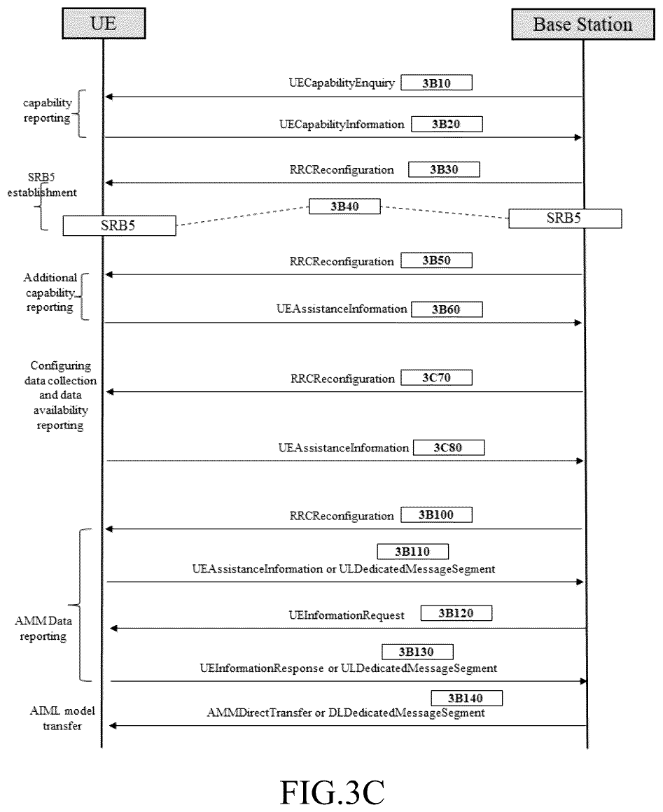

FIG. 3A illustrates protocol entities relevant to AI/ML operation.

For LCM of AI/ML on radio network, various functions (e.g. data collection, model training, model management etc.) needs to be performed by various entities (e.g. UE, base station, OTT server, OAM, LMF etc.) in collaborative manner.

Scattering these functions in the existing protocol entities is not scalable. In this disclosure, a new protocol entity in UE side is introduced for comprehensive management of AIML functions/features in terms of LCM.

In general, a protocol entity performs:
>external data exchange with the peer entities; and
>internal data exchange with other protocol entities.

For external data exchange, the new protocol entity (AI/ML Management protocol entity; AMM entity) is connected to both control plane connections (e.g. SRBs) and user plane connections (e.g. DRBs) and utilizes one of them depending on the peer entity and the use case at the given time.

AMM 3A10 in UE resides above LPP 3A20 and RRC 3A30 and PDCP 3A40 and SDAP 3A50.

AMM selects the lower layer for external data exchange considering various factors:
>in which network entity the peer AMM entity resides;
>which LCM stage for which AI/ML function/feature is being performed;
>which lower layer is available for external data exchange.

In case that the peer entity for external data exchange is GNB (e.g. the external data is coming from and going to the GNB), UE may use, for the external data exchange over the radio:
>SRB5; or
>special DRB;
>>the special DRB is a DRB that is connected neither to EPC nor to 5GC (nor to any other core network entity). The special DRB is used to convey upper layer data that is processed by the base station.
>>the special DRB consists of a PDCP and a RLC. The PDCP of the special DRB is not connected to SDAP. The PDCP is connected to AMM layer;
>>normal DRB (e.g. that is not special DRB) is connected either to EPC or 5GC. The normal DRB is used to convey user plane data (e.g. IP packet). The PDCP entity of normal DRB is connected to SDAP.

In case that the peer entity for external data exchange is LMF and that the use case is positioning, UE may use, for the external data exchange over the radio:
>SRB2.

In case that the peer entity for external data exchange is OTT/OAM, UE may use, for the external data exchange over the radio:
>DRB.

AMM in the UE side may perform:
>External data transfer with peer entity in GNB or in OAM or in OTT server or in LMF such as:
>>Model transfer;
>>Model update;
>>Feedback information;
>>Protocol control message such as Model request, Model update request, Model transfer etc;
>>>Adding/Removal Header on AMM SDU (e.g. Model request, Model data, Model update request . . . ); and
>>>segmentation and reassembly of AMM SDU;
>data path selection for external data transfer;
>OTT server selection;
>Model storage;
>Model transfer to the internal protocol entity;
>Model management;
>Triggering LCM related procedures in the lower layers (e.g. transmitting specific RRC message or specific MAC CE).

For data path selection:
>if the peer entity is GNB,
>>UE transmits a request in RRC message, wherein the request is one bit indication that radio bearer for AIML is required;
>>GNB establishes a SRB5 or a special DRB considering UE capabilities and GNB capabilities;
>>UE and GNB performs AIML data transfer (AIML data transmission and reception) via the established radio bearer for AIML;
>>>UE and GNB selects SRB5 for AIML data transfer if the SRB5 is established and the special DRB is not established;
>>>UE and GNB selects the special DRB for AIML data transfer if the SRB5 is not established and the special DRB is established;
>>>UE and GNB selects the special DRB or SRB5 based on other considerations if both the SRB5 and the special DRB is established;
>>>>other considerations comprise:
>>>>>the amount of data available for transmission in the corresponding LCG (radio bearer with less amount of data);
>>>>>whether the handover is pending (special DRB is selected if so);
>>>UE transmits the request in a RRC message if neither special DRB nor SRB5 is established;
>if the peer entity is LMF,
>>UE and GNB performs AIML data transfer via SRB2 or SRB1; and
>>>if SRB2 is established, via SRB2;
>>>if SRB2 is not established, via SRB1;
>>GNB and AMF performs AIML data transfer via GTP tunnel; and
>>AMF and LMF performs AIML data transfer via corresponding interface.
>if the peer entity is OTT server,
>>UE selects a DRB established for data transfer with OTT server.

External data comprises all types of data that are exchanged between peer entities for AI/ML purposes (e.g., model transfer to/from the peer entity, model update, feedback related to model transfer, capability reporting, applicability condition notification, additional condition notification etc.).

Internal data comprises all type of data that are exchanged between the AMM entity and protocol sublayer entities for AI/ML purposes. (e.g., model transfer to a lower layer protocol sublayer entity, request to a lower layer to initiate AIML related procedure, request to lower layer to transmit AIML related control signal).

In case of CSI enhancement, the internal data exchange may be performed between AMM and PHY.

In case of BM, the internal data exchange may be performed between AMM and MAC.

In case of positioning enhancement, the internal data exchange may be performed between AMM and LPP.

In case of mobility enhancement, the internal data exchange may be performed between AMM and RRC.

For special DRB or SRB5 establishment, RadioBearConfig is used.

FIG. 3B illustrates overall operation of the UE and network in embodiment 1.

UE and GNB performs capability reporting (3B10 and 3B20)

At 3B10, GNB transmits UE UECapabilityEnquiry via SRB1. In the message followings are included:
>>indication for applicable conditions (that applicable conditions is requested to be reported) may be present;
>>indication for model reporting (that supported model is requested to be reported) may be present.

At 3B20, UE transmits GNB UECapabilityInformation via SRB1. In the message:
>>applicable conditions are reported if the indication for applicable conditions is present in the UECapabilityEnquiry;
>>supported AIML feature/feature group/model is reported if the indication for model reporting is present in the UECapabilityEnquiry.

Applicable conditions (e.g., scenarios, sites, and datasets) are defined per AIML functionalities.

UE and GNB performs SRB5 establishment (3B30 and 3B40)

At 3B 30, GNB transmits UE RRCReconfiguration via SRB1. The message comprises a SRBToAddMod IE for SRB5. The SRBToAddMod IE for SRB5 comprises a specific field indicating SRB5.

At 3B40, GNB and UE establishes SRB5 according to the SRBToAddMod IE.

After SRB5 establishment, additional_capability_reporting procedure (3B 50 and 3B 60) can be performed.

UE and GNB configures AMM data availability reporting and additional capability reporting (3B50 and 3B60)

At 3B50, GNB transmits UE RRCReconfiguration via SRB1. The message may comprise following field/IE:
>>OtherConfig IE that contains configuration information for AIML data availability reporting;
>>>first threshold for AIML data availability reporting (e.g. two step reporting), wherein the first threshold indicates amount of collected data in byte;
>>>second threshold for immediate/direct/one step reporting;

UE determines based on the first threshold whether to send UAI comprising AIML data availability information. If the amount of collected data is greater than the first threshold, UE sends UAI comprising AIML data availability. UE determines based on the second threshold whether to perform one step reporting or two step reporting.

In one step reporting, UE transmits AIML data in UAI.

In two step reporting, UE transmits AIML data availability in the first UAI and transmits AIML data in second UAI (or in UEInformationResponse).

UE determines to report AIML data (e.g. to perform one step reporting) if the amount of AIML data is less than a second threshold.

At 3B60, UE transmits GNB UEAssistanceInformation via SRB1. The message comprises:
>>AMM container containing additional capability/conditions; and
>>Identification information related with the AMM container (e.g. associated model ID or associated function/feature/feature group . . . ).

UE and GNB performs training-data-collection-procedure (3B70).

At 3B70, GNB transmits UE a AMMDirectTransfer message via SRB5. The message comprises AMMDirectTransfer that includes a container for AMM entity (e,g. AMM container, octet string);

RRC layer forwards the AMM container to the AMM entity. The container contains a AMM control signal indicating start of AMM training data collection. The AMM control signal may comprise the information on training data to be collected. AMM entity in UE side controls the relevant protocol entity to start training data collection.

UE performs training data collection. UE may stop the training data collection and release the collected training data in the following case:
>RLF occurs; and
>selected cell due to cell selection while T311 is running is different from the cell where training data collection starts (or the PCell at the time when RLF occurs)

UE and GNB perform AMM data availability reporting (3B80 and 3B90).

At 3B80, GNB transmits UE RRCReconfiguration via SRB1. The message comprises OtherConfig. OtherConfig contains configuration information for AIML data availability reporting.

UE determines to report AIML data availability in case that:
>the amount of AIML data becomes equal to (or greater than) the first threshold, wherein the first threshold is indicated in the configuration information for AIML training data availability reporting; or
>battery power consumption due to AIML training data collection is higher than the level the UE can accept; or
>remaining battery power is less than an internal threshold; or
>remaining memory size is less than an internal threshold.

At 3B90, UE transmits GNB UEAssistanceInformation via SRB1. The message comprises AMM data availability report which comprises followings:
>the amount of AMM data;
>remaining time until discarding the AMM data;
>Identification information related with the AMM data (e.g. associated model ID or associated function/feature/feature group . . . .

UE and GNB perform AMM data reporting (3B100, 3B110, 3B120 and 3B130).

GNB determines to retrieve the AMM data.

In embodiment 1-1, GNB and UE performs followings.

At 3B100, GNB transmits UE RRCReconfiguration via SRB1. The message comprises OtherConfig. OtherConfig contains configuration information for AIML data reporting such as SegAllowed. The field indicates whether the UAI containing AIML data (e.g. AMM container) can be segmented. AMMDataRequested indicates that UE is requested to report AIML data;

UE generates an UAI containing AMM container (comprising training data). UE determines whether to segment the UAI or not.

UE determines which SRB between SRB1 and SRB5 to be used for UAI (or segment of UAI) transmission. Segment of UAI is transmitted via the SRB5. UAI comprising AMM container (assistance information that is terminated in upper layer such as AMM) is transmitted via the SRB5. UAI comprising AMM data availability report is transmitted via the SRB1. UAI comprising no AMM container (and comprising other assistance information that is terminated in RRC layer e.g. OverheatingAssistance or UEAssistanceInformation-v1610 IEs or UEAssistanceInformation-v1700 IEs) is transmitted via the SRB1.

At 3B110, UE transmits GNB UAI or ULDedicatedMessageSegment via SRB5. If handover is commanded by the GNB (i.e. RRCReconfiguration comprising ReconfigurationWithSync IE is received), and if there is remaining ULDedicatedMessageSegment, UE performs retransmission of the UAI (or ULDedicatedMessageSegment for which successful transmission is not confirmed by RLC layer) after successful completion of RACH procedure.

In embodiment 1-2, GNB and UE performs followings.

At 3B120, GNB transmits UE UEInformationRequest via SRB1. The message comprises UEInformationRequest-v1800. UEInformationRequest-v1800 contains configuration information for AIML data reporting. Configuration information for AIML data reporting comprises:
>SegAllowed indicates whether the UAI containing AIML data (e.g. AMM container) can be segmented; and
>AMMDataRequested indicated UE is requested to report AIML data.

UE generates an UEInformationResponse containing AMM container (comprising training data). UE determines whether to segment the UEInformationResponse or not. UE determines which SRB between SRB1 and SRB5 to be used for UEInformationResponse (or segment of UEInformationResponse) transmission.

Segment of UEInformationResponse is transmitted via the SRB5. UEInformationResponse comprising AMM container (UE information that is terminated in upper layer such as AMM) is transmitted via the SRB5 (if SRB5 is configured) or via the SRB2 (if SRB5 is not configured). UEInformationResponse comprising no AMM container (and comprising other UE information that is terminated in RRC layer e.g. UEInformationResponse-v1700-IEs) is transmitted via the SRB1.

At 3B130, UE transmits GNB UEInformationResponse or ULDedicatedMessageSegment via SRB5. If handover is commanded by the GNB (i.e. RRCReconfiguration comprising ReconfigurationWithSync IE is received), and if there is remaining ULDedicatedMessageSegment, UE performs retransmission of the UEInformationResponse (or ULDedicatedMessageSegment for which successful transmission is not confirmed by RLC layer).

UE and GNB perform AIML model transfer (3B140)

GNB determines to transfer AIML model to the UE. GNB generates a AMMDirectTransfer that contains AMM container that contains AIML model data and meta data of the AIML model data. GNB determines whether to segment the AMMDirectTransfer or not.

At 3B140, GNB transmits UE AMMDirectTransfer or DLDedicatedMessageSegment viaa SRB5. RRC layer forwards the AMM container to the AMM entity. AMM entity in UE side stores the AIML model data and the meta data.

FIG. 3C illustrates overall operation of the UE and network in embodiment 2.

UE and GBN performs 3B10, 3B20, 3Bb30, 3Bb40, 3B50 and 3B60.

At 3C70, GNB transmits UE RRCReconfiguration via SRB1. The message configures data collection and data availability reporting. The message comprises OtherConfig. OtherConfig contains configuration information for AIML data availability reporting and AMM container comprising AMM control signal. The AMM control signal may comprise the information on training data to be collected.

AMM entity in UE side controls the relevant protocol entity to start training data collection. UE performs training data collection.

UE may stop the training data collection and release the collected training data in the following case:
>RLF occurs; and
>selected cell due to cell selection while T311 is running is different from the cell where training data collection starts (or the PCell at the time when RLF occurs)

UE and GNB perform AMM data availability reporting.

UE determines to report AIML data availability when:
>the amount of AIML data is greater than the first threshold;
>the amount of AIML data becomes equal to (or greater than) the second threshold, wherein the threshold is indicated in the configuration information for AIML training data availability reporting; or
>battery power consumption due to AIML training data collection is higher than the level the UE can accept; or
>remaining battery power is less than a threshold; or
>remaining memory size is less than a threshold.

At 3C80, UE transmits GNB UEAssistanceInformation via SRB1. The message comprises AMM data availability report. It comprises:
>the amount of AMM data;
>remaining time until discarding the AMM data; and
>Identification information related with the AMM data (e.g. associated model ID or associated function/feature/feature group . . . .)

UE and GNB performs AMM data reporting.

GNB determines to retrieve the AMM data.

In embodiment 2-1, UE and GNB performs 3B100 and 3B110.

In embodiment 2-2, UE and GNB performs 3B120 and 3B130.

UE and GNB performs AIML model transfer (3B140).

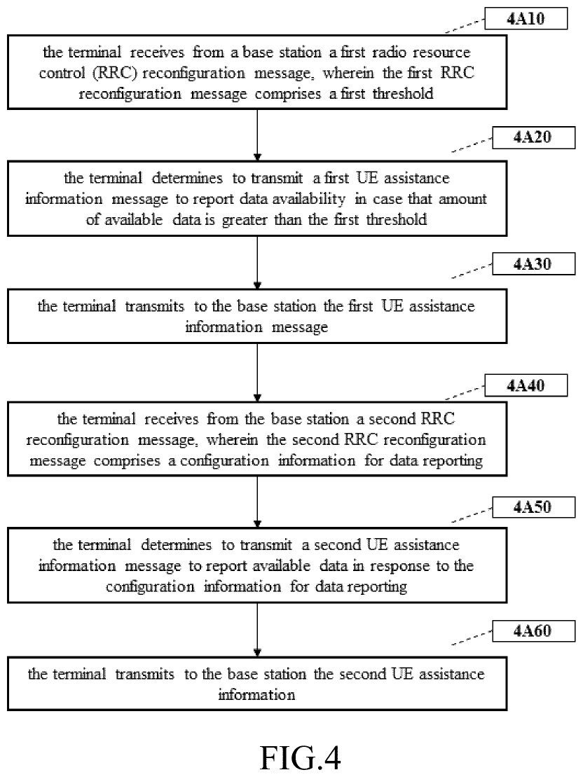

FIG. 4 is a flow diagram illustrating an operation of a terminal.

At 4A10, the terminal receives from a base station a first radio resource control (RRC) reconfiguration message, wherein the first RRC reconfiguration message comprises a first threshold;

At 4A20, the terminal determines to transmit a first UE assistance information message to report data availability in case that amount of available data is greater than the first threshold;

At 4A30, the terminal transmits to the base station the first UE assistance information message;

At 4A40, the terminal receives from the base station a second RRC reconfiguration message, wherein the second RRC reconfiguration message comprises a configuration information for data reporting;

At 4A50, the terminal determines to transmit a second UE assistance information message to report available data in response to the configuration information for data reporting;

At 4A60, the terminal transmits to the base station the second UE assistance information.

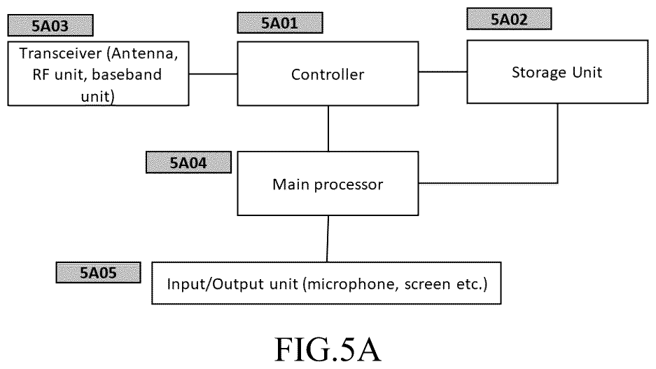

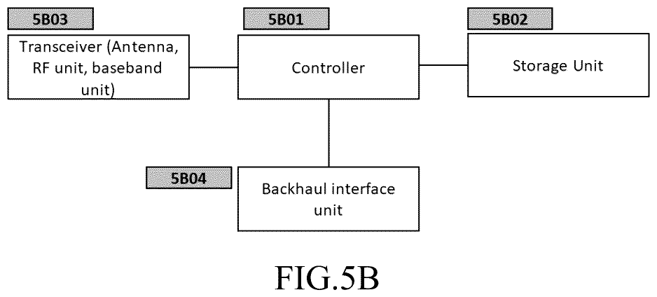

FIG. 5A is a block diagram illustrating the internal structure of a UE to which the disclosure is applied.

Referring to the diagram, the UE includes a controller 5A01, a storage unit 5A02, a transceiver 5A03, a main processor 5A04 and I/O unit 5A05.

The controller 5A01 controls the overall operations of the UE in terms of mobile communication. For example, the controller 5A01 receives/transmits signals through the transceiver 5A03. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations in the present disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

FIG. 5B is a block diagram illustrating the configuration of a base station according to the disclosure.

As illustrated in the diagram, the base station includes a controller 5B01, a storage unit 5B02, a transceiver 5B03 and a backhaul interface unit 5B04.

The controller 5B01 controls the overall operations of the main base station. For example, the controller 5B01 receives/transmits signals through the transceiver 5B03, or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation in the present disclosure.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to deter mine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

What is claimed is:

1. A method performed by a terminal, the method comprising:
receiving by the terminal from a base station a first radio resource control (RRC) reconfiguration message, wherein the first RRC reconfiguration message comprises a first threshold;
determining by the terminal to transmit a first UE assistance information message to report data availability in case that amount of available data is greater than the first threshold;
transmitting by the terminal to the base station the first UE assistance information message;
receiving by the terminal from the base station a second RRC reconfiguration message, wherein the second RRC reconfiguration message comprises a configuration information for data reporting;
determining by the terminal to transmit a second UE assistance information message to report available data in response to the configuration information for data reporting; and
transmitting by the terminal to the base station the second UE assistance information.
